(19) United States
(12) Patent Application Publication
(10) Pub. No.: US 2018/0143796 A1
(43) Pub. Date: May 24, 2018

(54) CONTENT CONTROL APPARATUS, AND CONTENT CONTROL METHOD

(71) Applicant: FUJITSU LIMITED, Kawasaki-shi (JP)

(72) Inventors: Yoshihiko MURAKAWA, Yokohama (JP); Keiju OKABAYASHI, Sagamihara (JP); Kota ITAKURA, Kawasaki (JP)

(73) Assignee: FUJITSU LIMITED, Kawasaki-shi (JP)

(21) Appl. No.: 15/797,658

(22) Filed: Oct. 30, 2017

(30) Foreign Application Priority Data
Nov. 21, 2016 (JP) 2016-225852

(51) Int. Cl. G06F 3/14; G06F 3/01

(52) U.S. Cl. CPC G06F 3/1431; G06F 3/017

(57) ABSTRACT

Disclosed is a content control apparatus including multiple display units having respective display areas arranged in a loop, a memory storing a set of instructions of a content control program, and one or more processors programmed to execute the set of instructions to perform a process. The process includes displaying a content on any one of the plurality of display units, transferring the content, in response to a sliding operation on the content displayed on a corresponding one of the display units, from the display unit acting as a starting point that initially displays the content, to pass sequentially through other display units, and stopping the content in response to the transferred content being transferred to a predetermined position.

### CROSS-REFERENCE TO RELATED APPLICATIONS

This application is based upon and claims the benefit of priority of the prior Japanese Patent Application No. 2016-225852, filed on Nov. 21, 2016, the entire contents of which are incorporated herein by reference.

### FIELD

The embodiments discussed herein relate to a content control apparatus, and a content control method.

### BACKGROUND

Multiple displays may be connected in response to a request for displaying a large number of contents on a large screen. For example, one wall of a room may be covered with multiple displays appearing as a single display; this may achieve a large screen.

FIG. 1 is a diagram illustrating an example of an environment using multiple displays that are arranged on the left and right walls, front and rear walls, ceiling, floor, table (table top), and the like. In such an environment with multiple displays, it is assumed that discussion and brainstorming will be performed on various themes.

FIG. 2 is a diagram illustrating an example of a scene of brainstorming, where contents of digital sticky notes with written ideas are arranged in a personal workspace, and the contents C1 and C2 to be shared with other members are transferred (dispatched) by the respective users to a shared space. This makes it easier for an administrative user to handle the contents in the shared space.

When transferring a content, a user drags (slides) the content with a finger or a pen and releases it; as a result, the content starts being transferred at an initial speed according to a speed of being dragged in a dragged direction, and stops after being transferred by a predetermined distance with deceleration including a virtual dynamic friction coefficient.

The related art technology (e.g., Patent Documents 1 and 2) discloses a control technique for using a large number of displays; however, the disclosed technology merely involves a display for browsing, and does not consider an operation on the displayed contents.

### RELATED ART DOCUMENTS

### Patent Documents

Patent Document 1: Japanese Laid-open Patent Publication No. 2012-124759
Patent Document 2: Japanese Laid-open Patent Publication No. 2006-189637

### SUMMARY

According to an aspect of embodiments, a content control apparatus includes multiple display units having respective display areas arranged in a loop, a memory storing a set of instructions of a content control program; and one or more processors programmed to execute the set of instructions to perform a process. The process includes displaying a content on any one of the plurality of display units, transferring the content, in response to a sliding operation on the content displayed on a corresponding one of the display units, from the display unit acting as a starting point that initially displays the content, to pass sequentially through other display units, and stopping the content in response to the transferred content being transferred to a predetermined position.

The object and advantages of the invention will be realized and attained by means of the elements and combinations particularly pointed out in the appended claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an example of an environment in which multiple displays are used;

FIG. 2 is a diagram illustrating an example of a scene of brainstorming;

FIGS. 3A to 3C are diagrams (part 1) illustrating an example of connection of displays;

FIG. 4 is a diagram (part 2) illustrating an example of connection of displays;

FIG. 5 is a diagram illustrating a configuration example of a system according to an embodiment;

FIG. 6 is a diagram illustrating functional configuration examples of a server apparatus and a display control apparatus;

FIG. 7 is a diagram illustrating examples of data structures of various tables;

FIG. 8 is a diagram illustrating hardware configuration examples of a server apparatus and a display control apparatus;

FIG. 9 is a sequence diagram illustrating an overall process example according to an embodiment;

FIG. 10 is a diagram (part 1) illustrating an operation example in a first process example;

FIG. 11 is a diagram (part 2) illustrating the operation example in the first process example;

FIG. 12 is an example of data managed in the first process example;

FIG. 13 is a diagram illustrating a flowchart in the first process example;

FIG. 14 is a diagram (part 1) illustrating an operation example in a second process example;

FIG. 15 is a diagram (part 2) illustrating the operation example in the second process example;

FIG. 16 is an example of data managed in the second process example;

FIG. 17 is a diagram illustrating a flowchart in the second process example;

FIG. 18 is a diagram illustrating an operation example in a third process example;

FIG. 19 is a diagram illustrating a flowchart in the third process example;

FIGS. 20A to 20E are diagrams illustrating calculation formulas in the third process example;

FIG. 21 is a diagram illustrating an example of a case where determination is made by a total of transfer angles per unit time;

FIGS. 22A and 22B are diagrams illustrating an example of setting of a dynamic friction coefficient in the vicinity of a boundary in a fourth process example;

FIG. 23 is a diagram illustrating examples of normal distributions;

FIG. 24 is a diagram illustrating a flowchart in the fourth process example; and

FIGS. 25A to 25C are diagrams illustrating calculating formulas in the fourth process example.

### DESCRIPTION OF EMBODIMENTS

As described above, when an operation to transfer the contents is performed in an environment in which multiple displays are connected, and display areas of the displays are arranged in a loop, the transferred content does not stop promptly, which will result not obtaining an operation result as desired. Note that the arrangement in the loop refers to a mode in which a display area of one display is connected via a display area of another display to the display area of the initial one display.

That is, a predetermined dynamic friction coefficient is virtually set for transferring the contents; however, when a user drags the content vigorously and releases the content, the transferred content does not stop at a desired destination and may still continue moving after having returned to the original position.

Accordingly, in one aspect, it is an object of the present invention to stop a content that has undergone a transfer operation from continuing to be transferred, even when the display areas are arranged in a loop.

The following illustrates preferred embodiments with reference the accompanying drawings.

### Display Connection

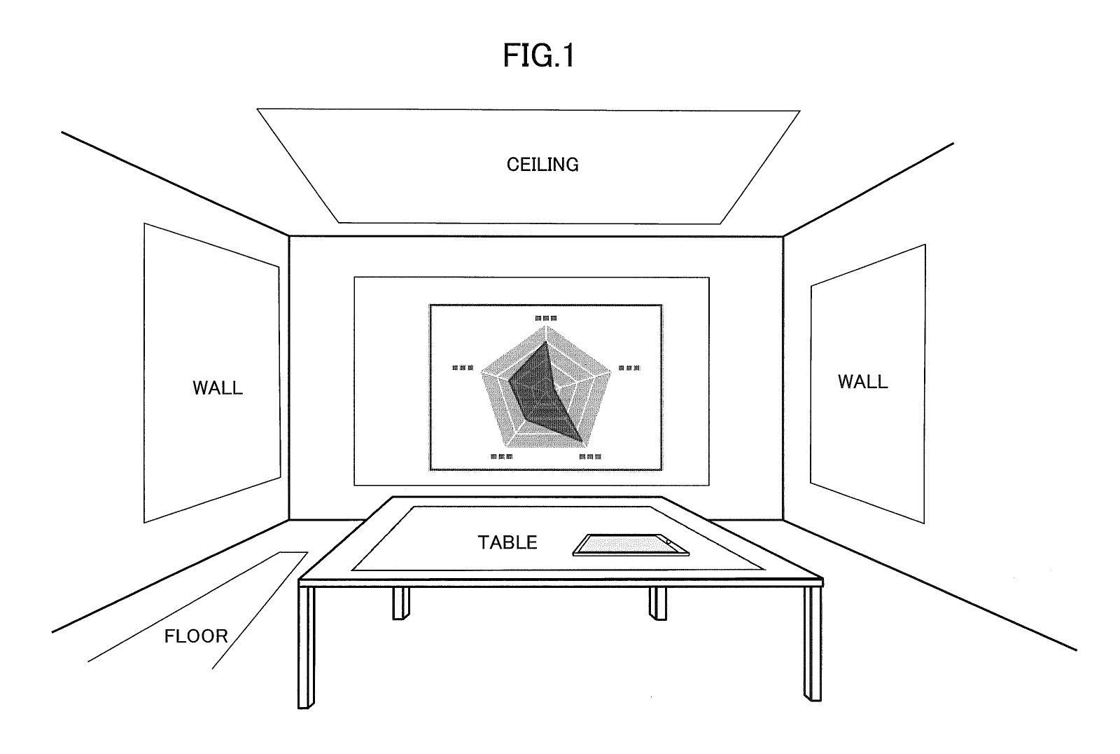

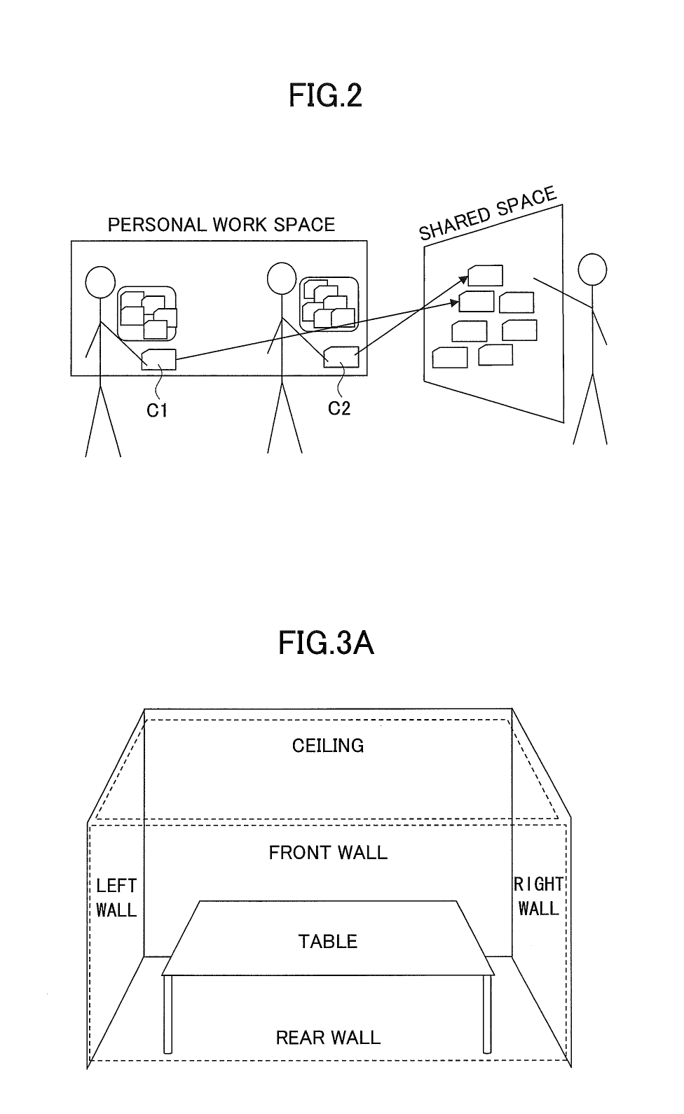

A direction of a content being displayed on a display (screen) is straightforward in the case of all displays (screens) being oriented in the same direction. However, when the displays are in various locations in a room as illustrated in FIG. 1, it is necessary to determine a display direction of a content in order to transfer the content between the displays. That is, a display method that is reasonable and easy to understand is required by controlling the connection method of the displays and the directions of the displayed content.

The connection of the displays and the direction of the displayed content may be controlled by determining upward and downward directions and leftward and rightward directions on each display in advance so as to display the content in the corresponding determined direction when transferring the content between the displays. However, the direction of the displayed content changes every time the content is transferred between displays; hence, a user and viewers need to be conscious of the direction with respect to each display.

In addition, in a case of a table, a table is not used from one direction only and may be used in all directions; from the top, bottom, left, and right. Accordingly, it will be complicated to control determining the directions in advance, specifically, in a case of a large number of displays.

In order to handle such complications, a model (sphere geometry) is introduced; this model includes projecting a display from the center of a circumscribed sphere to a spherical surface of the circumscribed sphere of a certain space (room), developing the projected display as a plane, and capturing connection relationships between the displays. That is, it is assumed that all displays are in contact with some adjacent display, and transferring a content between the displays is controlled based on the connection relationships.

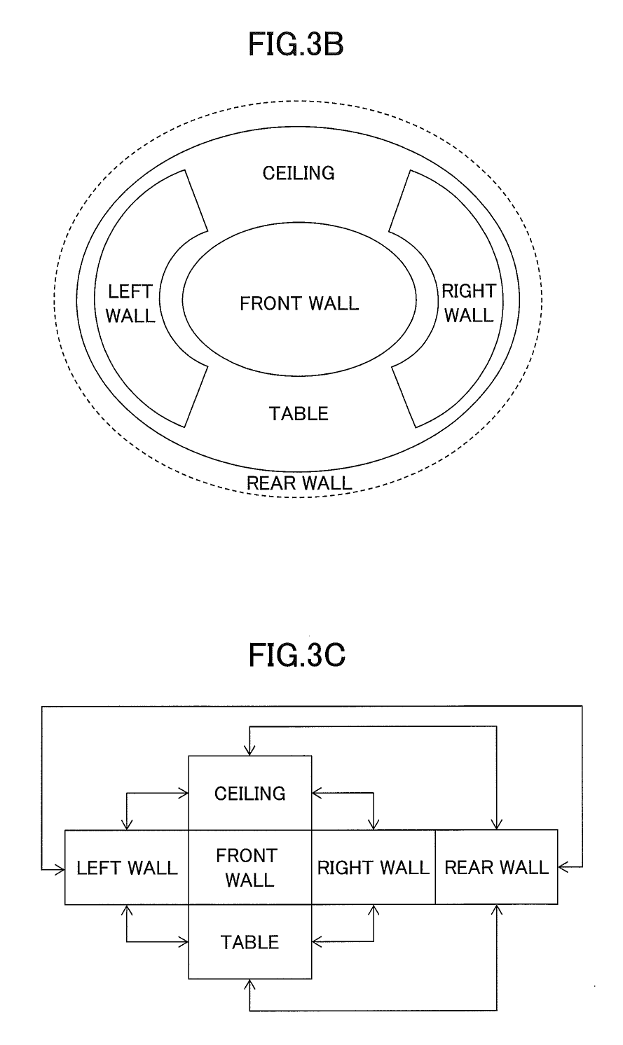

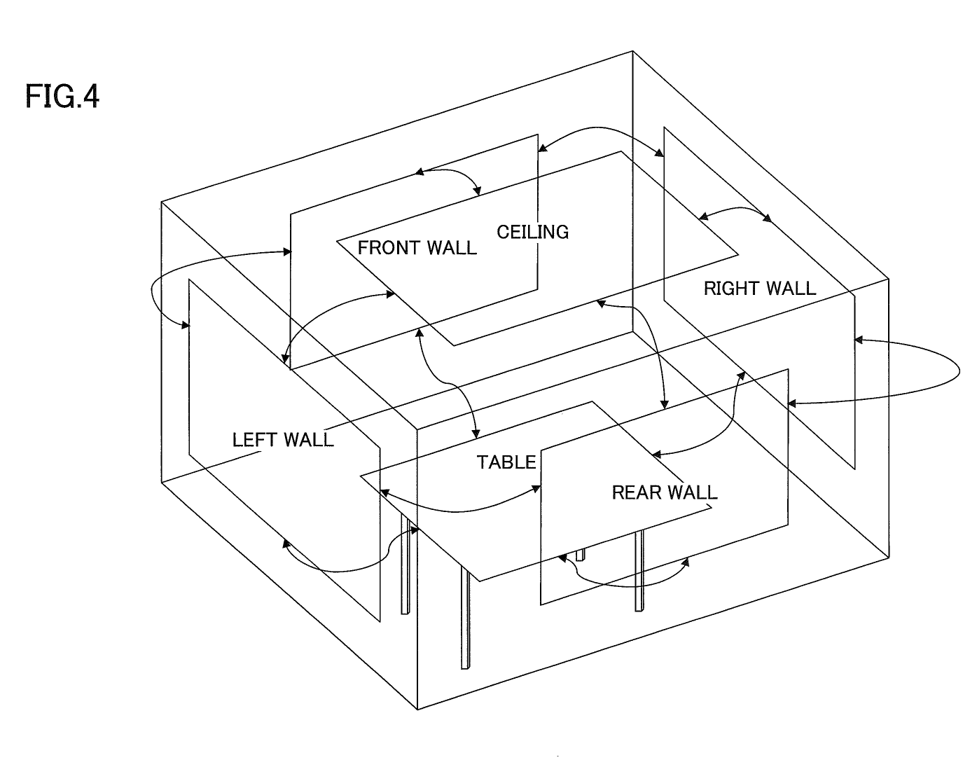

As illustrated in FIG. 3A, when displays are arranged on left and right walls, front and rear walls, the ceiling, and a table of the room, respectively, and the displays are developed as a plane, the displays are arranged as illustrated in FIG. 3B. Further, FIG. 3C illustrates connection relationships between the front wall, the left wall, the right wall, the ceiling, the table, and the rear wall with supplementary lines with arrows. In addition, FIG. 4 illustrates the connection relationship between respective displays stereoscopically.

### System Configuration

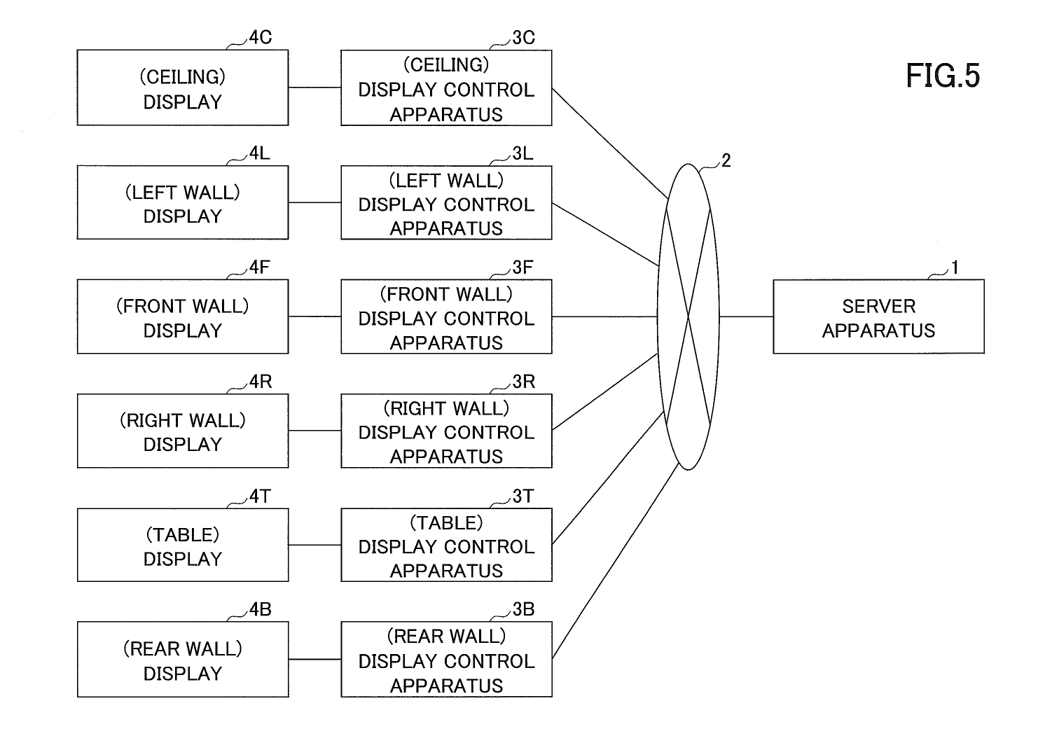

FIG. 5 is a diagram illustrating a configuration example of a system according to an embodiment, which is an example of an environment provided with six displays (display units) of front wall, left wall, right wall, ceiling, table, and rear wall as illustrated in FIG. 4. In FIG. 5, the system includes display control apparatuses 3 (3F, 3L, 3R, 3C, 3T, 3B) configured to control respective display units 4 (4F, 4L, 4R, 4C, 4T, 4B) and that are connected to a server apparatus 1 via a wired or wireless network 2. Examples of the display unit 4 include a projector, and a flat panel such as an LCD (Liquid Crystal Display). Further, a touch panel or the like is provided on the surface of the display unit 4 such that coordinate information of an operation by a user's finger or pen may be acquired. Note that one display control apparatus 3 is provided for each display unit 4; however, a smaller number of display control apparatuses 3 than of the display units 4 may control the display units 4. In addition, any of the display control apparatuses 3 may have the function of the server apparatus 1.

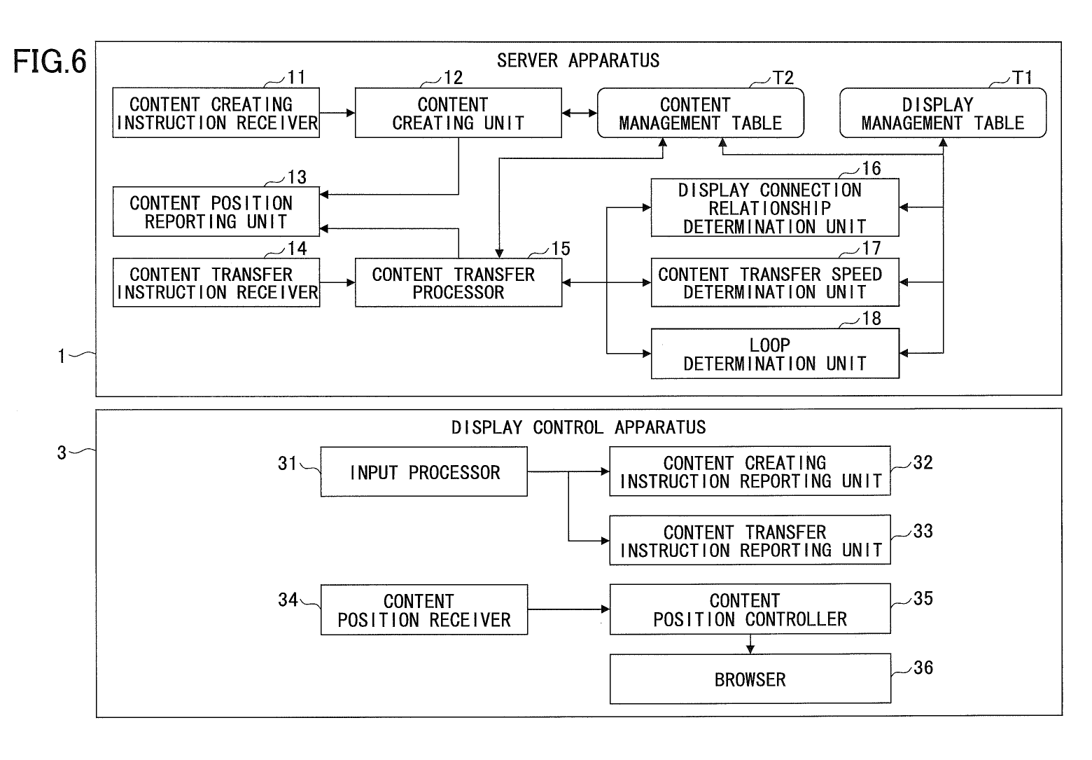

FIG. 6 is a diagram illustrating a functional configuration example of the server apparatus 1. In FIG. 6, the server apparatus 1 includes a content creating instruction receiver 11, a content creating unit 12, and a content position reporting unit 13. In addition, the server apparatus 1 includes a content transfer instruction receiver 14, a content transfer processor 15, a display connection relationship determination unit 16, a content transfer speed determination unit 17, and a loop determination unit 18. The server apparatus 1 includes a display management table T1 and a content management table T2 for referring/updating at the time of processing.

The content creating instruction receiver 11 has a function of receiving a content creating instruction from any one of the display control apparatuses 3. The content creating instruction is, for example, an instruction to create a digital sticky note, and includes an identifier of the display unit 4 on which handwriting input or the like has been performed, input coordinates (coordinates of a representative position where input is made), input contents (character string) and the like.

The content creating unit 12 has a function of creating content based on the content creating instruction received by the content creating instruction receiver 11. Information of the created content is stored in the content management table T2.

The content position reporting unit 13 has a function of reporting the identifier and display position of the content created by the content creation unit 12 to the display control apparatus 3 corresponding to the display unit 4 that displays the content. The content position reporting unit 13 also has a function of reporting a content and a display position to be transferred by the content transfer processor 15 to the display control apparatus 3 corresponding to the display unit 4 that displays the content.

The content transfer instruction receiver 14 has a function of receiving a content transfer instruction from any one of the display control apparatuses 3. The content transfer instruction is provided with the identifier of the content to be transferred, the transfer direction, the speed of the transferring operation, and the like.

The content transfer processor 15 has a function of transferring the content based on the content transfer instruction received by the content transfer instruction receiver 14. Information of the transferred content is stored in the content management table T2.

The display connection relationship determination unit 16 has a function of determining whether the content is transferred from one display unit 4 to another display unit 4 in the processing in the content transfer processor 15. The display connection relationship determination unit 16 refers to the display management table T1 and the content management table T2 at the time of processing.

The content transfer speed determination unit 17 has a function of determining the transfer speed of the content at the time of processing with respect to the content transfer processor 15. The content transfer speed determination unit 17 refers to the content management table T2 at the time of processing. It is assumed that the transfer speed imitates an object that slides while decelerating with a predetermined dynamic friction coefficient on the ground plane. That is, the transfer speed starts from the initial speed corresponding to the speed of the operation, and gradually decelerates with respect to the direction in which the operation for transferring the content was performed.

The loop determination unit 18 has a function of determining whether to stop the transferred content in order to prevent the content from continuing circling around due to the loop of the display areas according to whether the transferred content has attained a position to stop, with respect to the processing of the content transfer processor 15. The loop determination unit 18 refers to the display management table T1 and the content management table T2 at the time of processing. As will be described later, when maximizing the dynamic friction coefficient at the boundary or the like such that the content stops spontaneously at the boundary or the like, a function of the loop determination unit 18 is performed by the content transfer processor 15.

The display control apparatus 3 includes an input processor 31, a content creating instruction reporting unit 32, a content transfer instruction reporting unit 33, a content position receiver 34, a content position controller 35, and a browser 36.

The input processor 31 has a function of receiving an operation input by a user. The present embodiment involves an operation for creating a content and an operation for transferring the content; however, the operation input is not specifically limited to these examples. The operation for creating the content is performed by handwriting input to a desired position on the display unit 4, for the digital sticky note. The operation for transferring the content is performed by dragging (sliding operation) the content displayed on the display unit 4.

The content creating instruction reporting unit 32 has a function of reporting a content creating instruction to the server apparatus 1 when the input processor 31 receives an operation for creating the content. The information included in the content creating instruction is as described above.

The content transfer instruction reporting unit 33 has a function of transferring a content transfer instruction to the server apparatus 1 when the input processor 31 receives an operation for transferring the content. The information included in the content transfer instruction is as described above.

The content position receiver 34 has a function of receiving a content position reporting instruction from the server apparatus 1. The content position report includes an identifier of the content and a display position. The detail of the content may be obtained based on an identifier of the content.

The content position controller 35 has a function of controlling a display position of the content based on the identifier and the display position of the content received by the content position receiver 34.

The browser 36 has a function of displaying the content corresponding to the display position instructed by the content position controller 35.

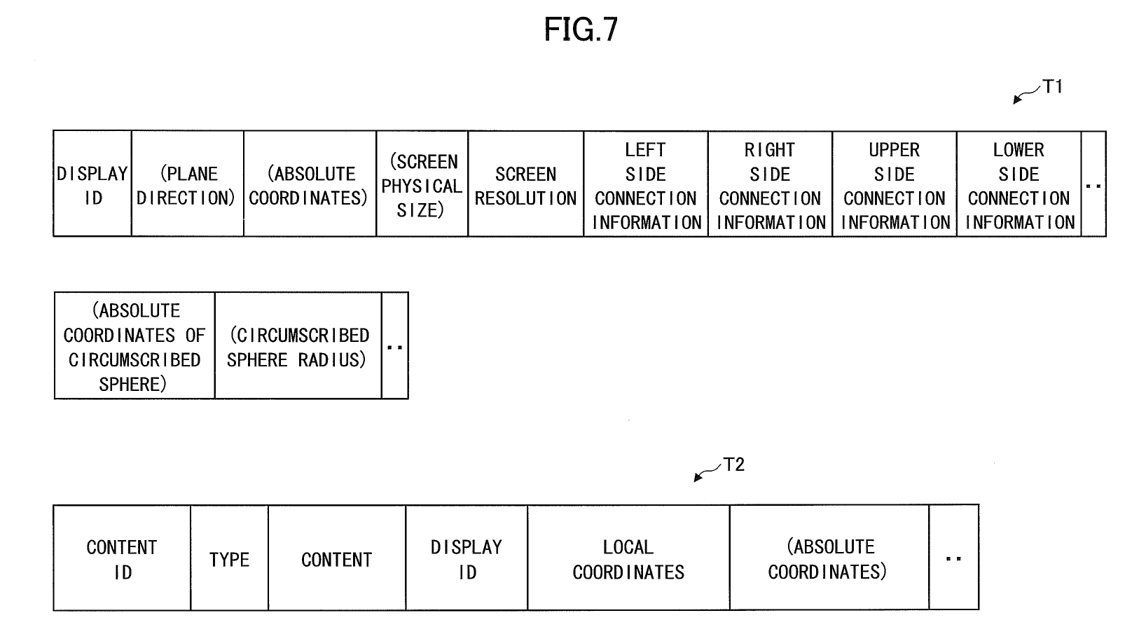

FIG. 7 is a diagram illustrating examples of data structures of various tables. In FIG. 7, the display management table T1 includes items such as “display ID”, “(surface direction)”, “(absolute coordinates)”, “(screen physical size)”, “screen resolution”, “left side connection information”, “right side connection information”, “upper side connection information”, and “lower connection information”. The display management table T1 has information of “(circumscribed sphere absolute coordinate)” and “(circumscribed sphere radius)” separately from the information for each display. Note that “(surface direction)”, “(absolute coordinates)”, “(physical screen size)”, “(absolute coordinates of circumscribed sphere)”, and “(circumscribed sphere radius)” are used for converting the position on the display unit 4 mutually between local coordinates (two-dimensional coordinates on the screen) and absolute coordinates (three-dimensional coordinates). Hence, the above items may be unnecessary in a case of performing processing on local coordinates in the first process example and the second process example described later.

The “display ID” is information (identifier) for identifying a display unit 4. The “(surface direction)” represents, for example, three-dimensional rotation to the target display unit 4 with the Euler angle, roll, pitch, yaw etc. on the basis of the front display unit 4 (on the front wall). The “(absolute coordinates)” is the absolute coordinates of the base point of the display unit 4 (e.g., the lower left corner of the screen acting as the origin of the local coordinates). The “(screen physical size)” is a physical length in vertical and horizontal directions of the screen of the display unit 4. The “screen resolution” is the number of vertical and horizontal pixels on the screen of the display unit 4.

The “left side connection information” is connection information on the screen of another display unit 4 connected to the left side of the display unit 4, including a display ID and a connection range (a range within which the side may be connected, the position of the connected counterpart etc.). The “right connection information”, “upper connection information” and “lower connection information” are connection information on the right side, the upper side, and the lower side of the display unit 4, respectively.

The “(circumscribed sphere absolute coordinates)” is absolute coordinates of the center of a sphere (circumscribed sphere) circumscribing the space (room) where the display unit 4 is arranged. The “(circumscribed sphere radius)” is a radius of the circumscribed sphere.

The content management table T2 has items such as “content ID”, “type”, “detail”, “display ID”, “local coordinates”, and “(absolute coordinates)”. Hence, the “(absolute coordinates)” may be unnecessary in a case of performing processing on local coordinates in the first process example and the second process example described later.

The “content ID” is information (identifier) for identifying a content. T “type” is information indicating a type of content (e.g., a digital sticky note). The “detail” is a detail of content (a character string to be entered in the case of digital sticky notes). The “display ID” is a display ID of the display unit 4 on which the content is currently displayed. The “local coordinates” is local coordinates of the base point of the content. The “(absolute coordinates)” is absolute coordinates of the base point of the content.

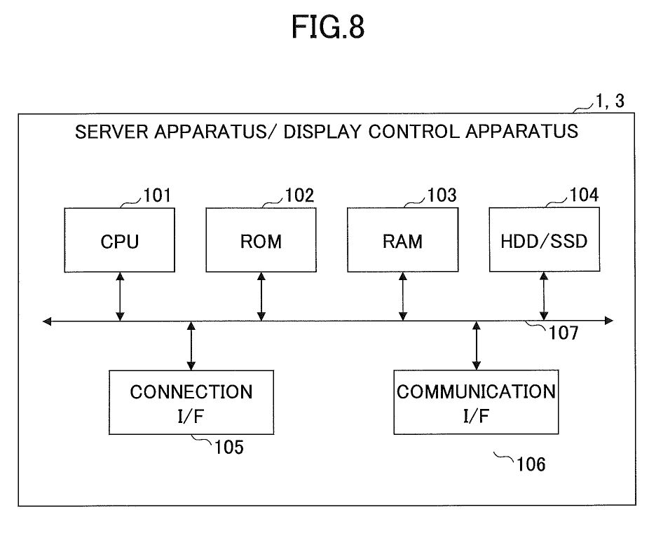

FIG. 8 is a diagram illustrating a hardware configuration example of the server apparatus 1 and the display control apparatus 3, each of which has a configuration of a general information processing apparatus (computer). In FIG. 8, the server apparatus 1 and the like include a CPU (Central Processing Unit) 101, a ROM (Read Only Memory) 102, a RAM (Random Access Memory) 103, and a HDD (Hard Disk Drive)/SSD (Solid State Drive) 104. Further, the server apparatus 1 and the like include a connection I/F (interface) 105 and a communication I/F 106.

The CPU 101 comprehensively controls operations of the server apparatus 1 and the like by executing programs stored in the ROM 102 or the HDD/SSD 104 or the like, using the RAM 103 as a work area. The connection I/F 105 is an interface with a device or an apparatus connected to the server apparatus 1 and the like. The communication I/F 106 is an interface for communicating with another information processing apparatus via a network.

The functions of the server apparatus 1 and the like described with reference to FIG. 6 are implemented by executing a predetermined program with respect to the CPU 101. The program may be acquired via a recording medium, may be acquired via a network, or may be embedded in a ROM.

### Overall Process Example

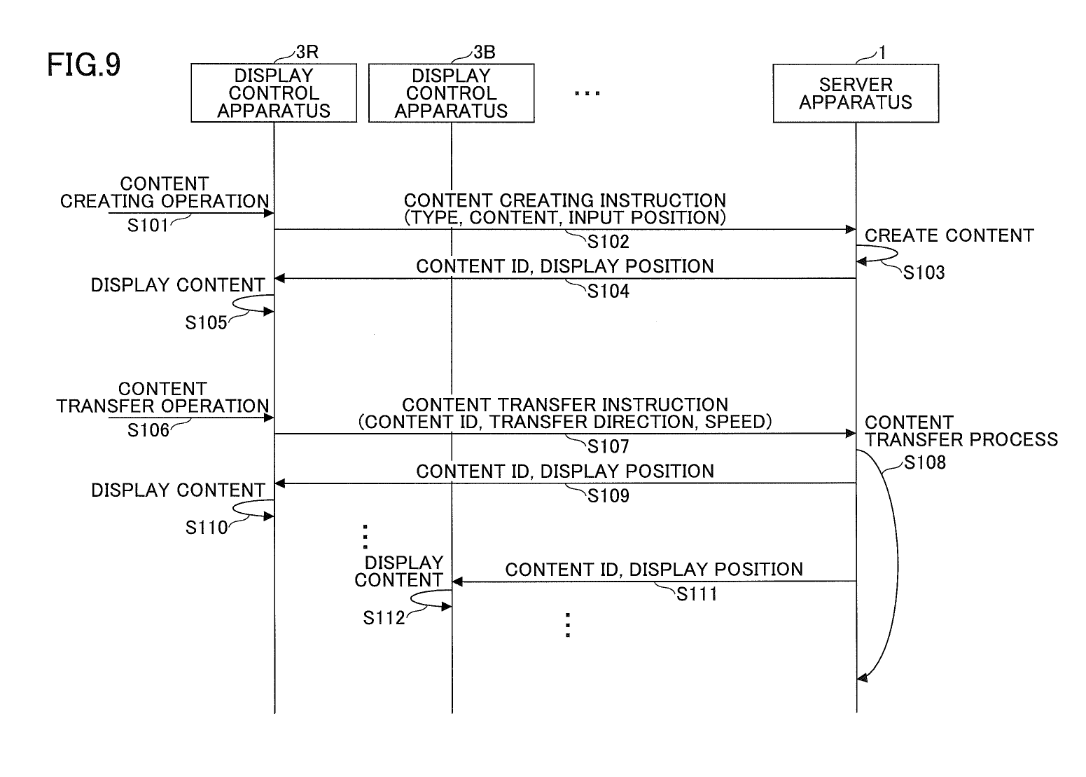

FIG. 9 is a sequence diagram illustrating a process example according to the embodiment. In FIG. 9, when a user intends to create a content such as a digital sticky note, the user performs a content creating operation on, for example, a display unit 4R (not illustrated) near the user, and this user's operation is performed by an input processor 31 of a corresponding display control apparatus 3R (step S101). In response to the input content creating operation, the content creating instruction reporting unit 32 of the display control apparatus 3R reports a content creating instruction accompanied by the content type, content (character string, etc.), input position, and the like to the server apparatus 1 (step S102).

When the content creating instruction receiver 11 of the server apparatus 1 receives the content creating instruction, the content creating unit 12 creates a content according to the content creating operation and registers information of the created content in the content management table T2 (step S103). For example, in a case of creating a digital sticky note, a new content ID is issued, the input character string is used as a content, local coordinates starting from the input position are set as a display position, and the ID of the display unit 4R is set as a display ID. Then, the content position reporting unit 13 reports the content ID and display position of the created content to the display control apparatus 3R corresponding to the display unit 4R to which the input operation has been performed (step S104).

When the content position receiver 34 of the display control apparatus 3R receives the report of the content ID and the display position, the content position controller 35 instructs the browser 36 to display the content, and the browser 36 displays the content on the corresponding display unit 4R (step S105). When the browser 36 does not hold the content display data, the browser 36 acquires content display data based on the content ID from the server apparatus 1.

When the user intends to transfer the display position of the content, the user performs a content transfer operation on the display unit 4R on which the content is displayed, and this operation is input by the input processor 31 of the corresponding display control apparatus 3R (step S106). For example, when the user intends to “throw” the content to a distant position, the user momentarily drags the content with the user's hand in a direction in which the content is desired to be thrown, and releases the user's hand. In response to the input content transfer operation, the content transfer instruction reporting unit 33 of the display control apparatus 3R reports the content transfer instruction accompanied by the content ID, the transfer direction, the dragging speed, and the like to the server apparatus 1 (step S107).

When the content transfer instruction is received by the content transfer instruction receiver 14 of the server apparatus 1, the content transfer processor 15 performs a content transfer process (step S108). This transfer process is performed by the content transfer speed determination unit 17, the display connection relationship determination unit 16, and the loop determination unit 18. That is, the content transfer speed determination unit 17 determines a transfer speed of the content in consideration of an initial speed of the content and a dynamic friction coefficient. The display connection relationship determination unit 16 determines whether the content is transferred across the displays. The loop determination unit 18 determines whether to stop the content according to whether the content has attained a predetermined position. Details of the process will be described later.

Then, the content transfer processor 15 reports the content ID and the display position of a transfer destination to the display control apparatus 3R via the content position reporting unit 13, with a predetermined time as a unit (step S109). When the content position receiver 34 of the display control apparatus 3R receives the report of the content ID and the display position, the content position controller 35 instructs the browser 36 to display the content. Then, the browser 36 displays the content (accompanied by erasing the original display) on the corresponding display unit 4R (step S110).

Since the content continues to be transferred while decelerating by the dynamic friction coefficient, reporting of the content ID and the display position of the transfer destination from the server apparatus 1 is repeated with a predetermined time as a unit, and the display control apparatus 3R performs display control. When the content enters the display area of, for example, an adjacent display unit 4B, the content ID and the display position of the transfer destination are reported to the corresponding display control apparatus 3B (step S111), and the display control apparatus 3B displays the content on the display unit 4B (step S112). These processes are repeated until the content transferred is stopped.

### First Process Example

In the first process example, a fixed boundary (boundary line) is set in either a vertical direction or a horizontal direction on any of the displays 4 in order to stop the content that has been transferred to the boundary. The content stopped at the boundary is released and becomes transferrable once the stop from the boundary is released, and after passing through the boundary, the released content is again stopped at the next pass.

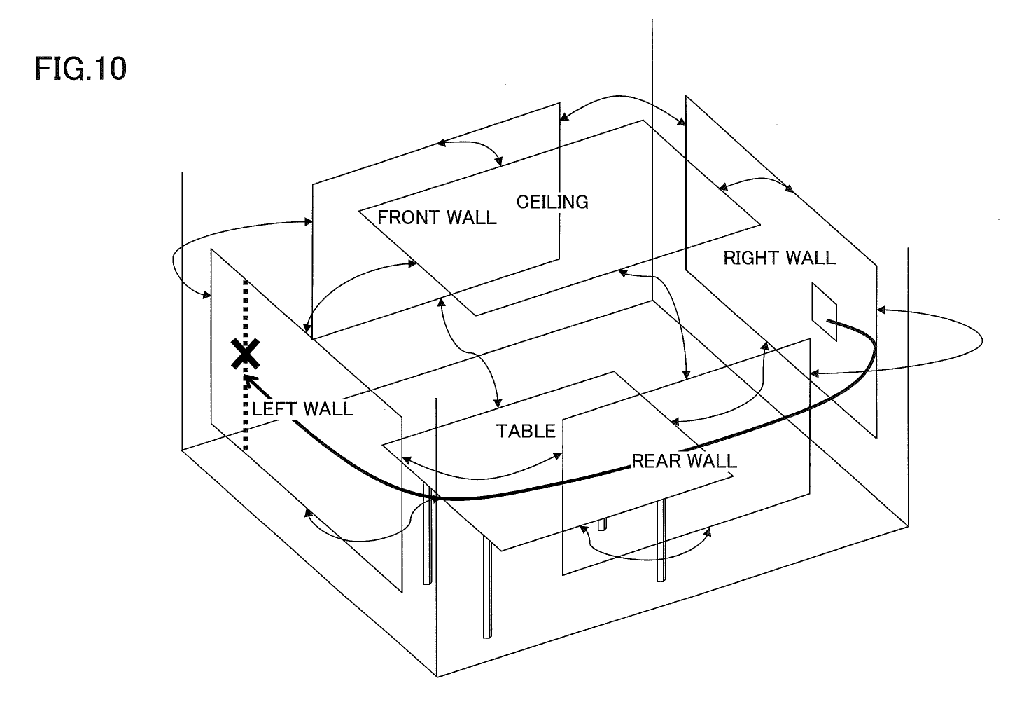

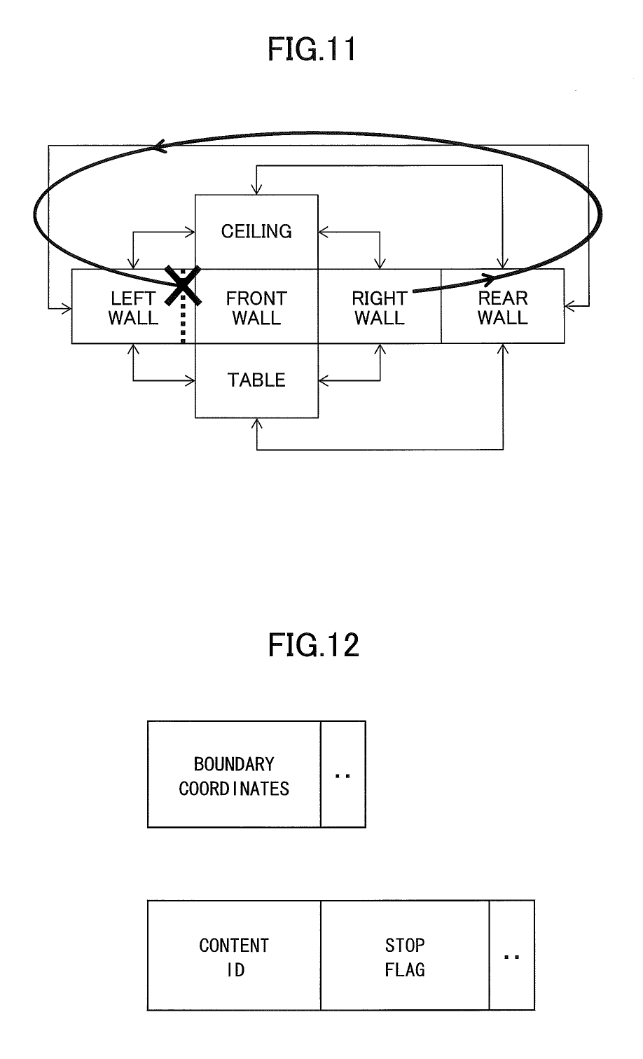

FIG. 10 is a diagram illustrating an operation example in the first process example, in which the display unit 4 is arranged on the front wall, the left wall, the right wall, the ceiling, the table, and the rear wall, similar to the case illustrated in FIG. 4. Further, in this example, a vertical boundary is provided in a part of the left wall as indicated by a broken line. In this state, for example, when an operation for vigorously transferring the content displayed on the right wall to the right direction is performed, the content enters the left wall via the rear wall as indicated by a thick line. Thereafter, when the content attains the boundary, the content is stopped as indicated by “x”. As a result, even when the transfer operation is too strong without adjustment, it is possible to prevent the content from continuing circling around. FIG. 11 illustrates a similar operation as in FIG. 10 in a state where the displays are developed as a plane similar to FIG. 3C.

FIG. 12 illustrates an example of data managed by the first process example, which has data for setting boundary coordinates and a stop flag for each content. When an x axis of the local coordinates represents a horizontal direction and a y axis of the local coordinates represents a vertical direction, a y coordinate value of the local coordinates indicates the boundary coordinates for setting the boundary in the vertical direction, and an x coordinate value of the local coordinates indicates the boundary coordinates for setting the boundary in the horizontal direction. The stop flag signifies stopping without allowing passing through the boundary when ON, and permits passing through the boundary when OFF.

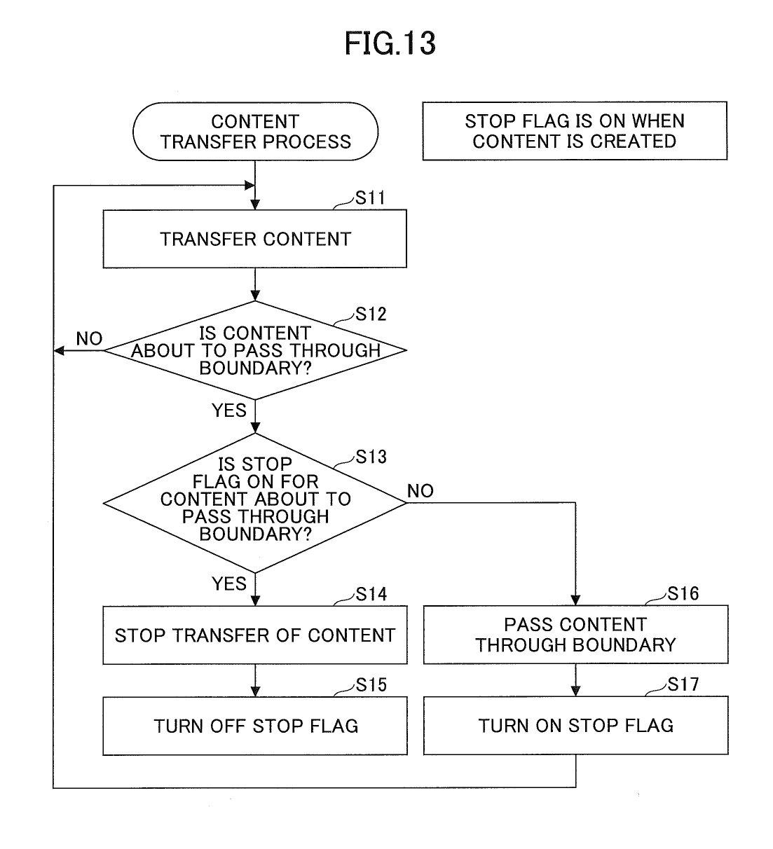

FIG. 13 is a diagram illustrating a flowchart in the first process example, which indicates a process corresponding to the content transfer process (step S108) in FIG. 9. In FIG. 13, when starting the process, the content transfer processor 15 obtains the display position of the content after a unit time on the display based on the transfer direction and the transfer speed determined by the content transfer speed determination unit 17, and transfers the content (step S11).

Subsequently, the content transfer processor 15 determines whether the content is about to pass through the boundary (step S12).

When the content transfer processor 15 determines that the content is not about to pass through the boundary (No in step S12), the content transfer processor 15 returns to the transfer of the content (step S11).

When the content transfer processor 15 determines that the content is about to pass through the boundary (Yes in step S12), the content transfer processor 15 determines whether the stop flag of the content is ON (step S13). Note that it is assumed that the stop flag is set to ON at the time of content creation.

When the content transfer processor 15 determines that the stop flag of the content is ON (Yes in step S13), the content transfer processor 15 stops the transfer of the content (step S14) and sets the stop flag of the content to OFF (step S15).

When the content transfer processor 15 determines that the stop flag of the content is OFF (No in step S13), the content transfer processor 15 passes the content through the boundary (step S16), sets the stop flag of the content to ON (step S17), and continues the transferring process.

### Second Process Example

In the second process example, the boundary is not fixed; the boundary is instead dynamically set at the transfer start position for each content in order to stop the content that has again attained the boundary.

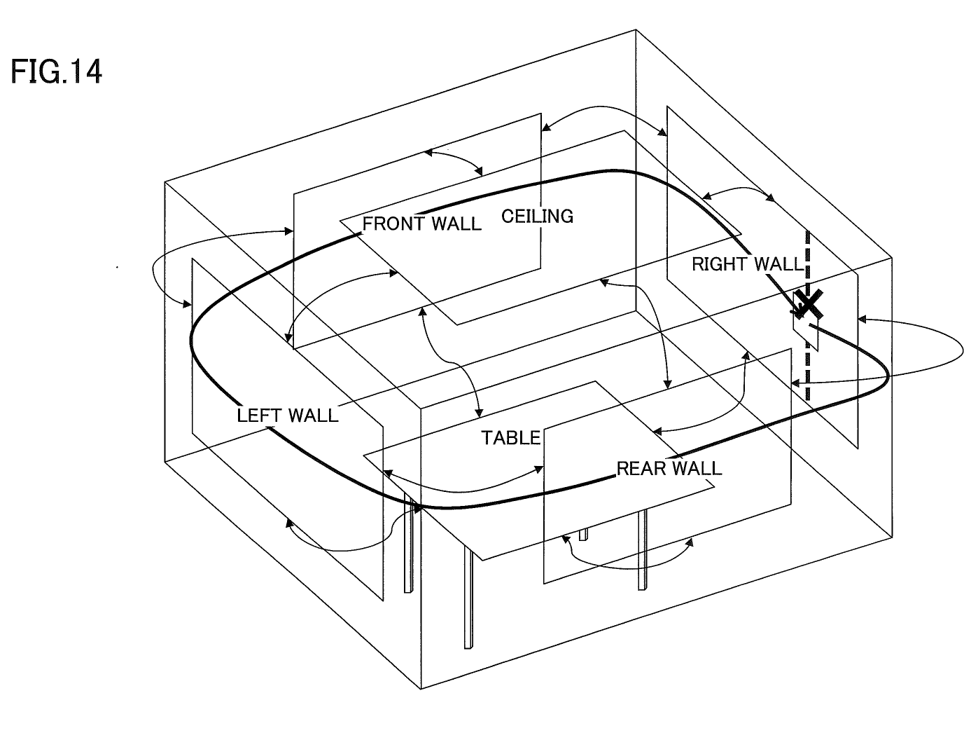

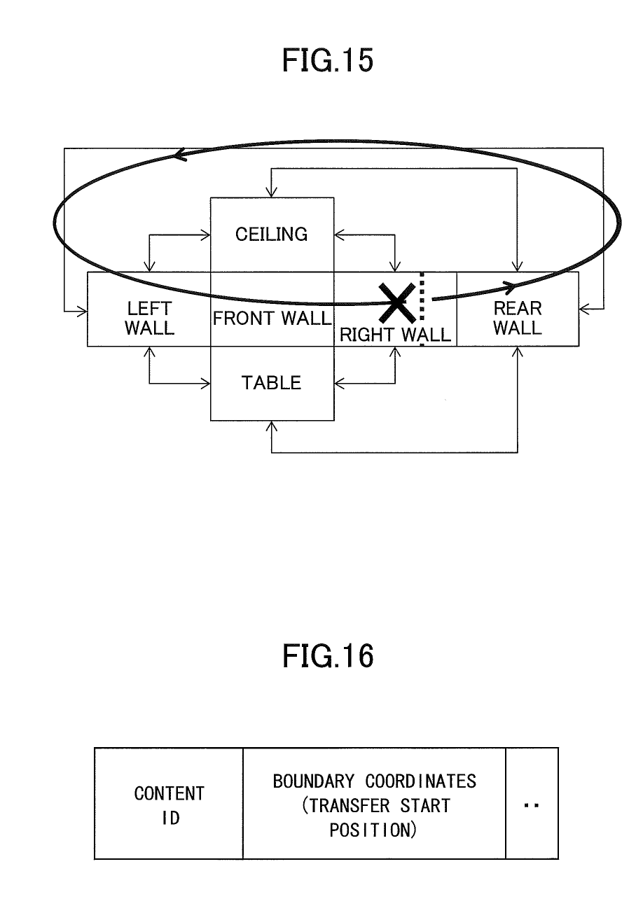

FIG. 14 is a diagram illustrating an operation example in the second process example, in which the display 10 is arranged on the front wall, the left wall, the right wall, the ceiling, the table, and the rear wall, similar to the case illustrated in FIG. 10. In this state, for example, when an operation for vigorously transferring the content displayed on the right wall to the right direction is performed, a boundary indicated by a broken line is initially set at the transfer start position. Then, the content is transferred and enters the right wall again sequentially via the rear wall, the left wall and the front wall as indicated by a thick line. Thereafter, when the content attains the boundary corresponding to the transfer start position, the content is stopped as indicated by “x”. As a result, even when the transfer operation is too strong without adjustment, it is possible to prevent the content from continuing circling around. FIG. 15 illustrates a similar operation as in FIG. 14 in a state where the displays are developed as a plane similar to FIG. 11.

FIG. 16 illustrates an example of data managed by the second process example, and boundary coordinates corresponding to the transfer start position are held for each content.

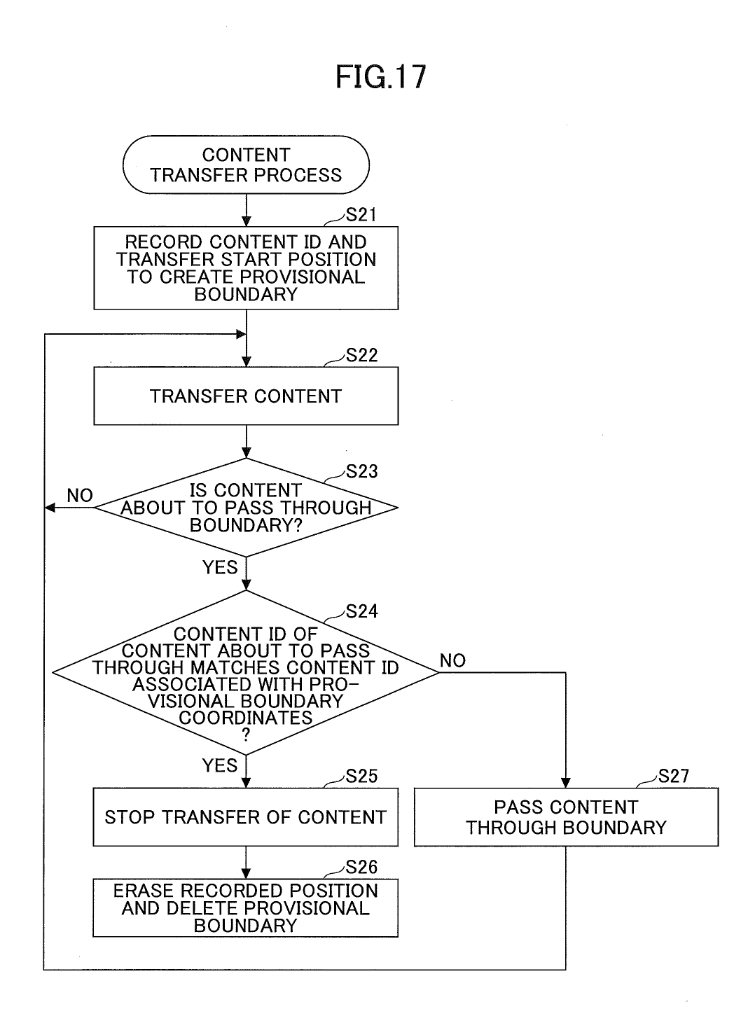

FIG. 17 is a diagram illustrating a flowchart in the second process example, which indicates a process corresponding to the content transfer process (step S108) in FIG. 9. In FIG. 17, when starting the process, the content transfer processor 15 records the content ID and the transfer start position in association with each other to create a provisional boundary (step S21).

Subsequently, the content transfer processor 15 obtains the display position of the content after a unit time on the display based on the transfer direction and the transfer speed determined by the content transfer speed determination unit 17, and transfers the content (step S22).

Subsequently, the content transfer processor 15 determines whether the content is about to pass through the boundary (step S23).

When the content transfer processor 15 determines that the content is not about to pass through the boundary (No in step S23), the content transfer processor 15 returns to the transfer of the content (step S22).

When the content transfer processor 15 determines that the content is about to pass through the boundary (Yes in step S23), the content transfer processor 15 determines whether the content ID of the content that is about to pass through the boundary matches the content ID associated with the boundary coordinates (step S24).

When the content transfer processor 15 determines that the two content IDs match (Yes in step S24), the content transfer processor 15 stops the transfer of the content (step S25), and then erases the recorded corresponding position and deletes the provisional boundary (Step S26).

When the content transfer processor 15 determines that the two content IDs do not match (No in step S24), the content transfer processor 15 passes the content through the boundary (step S27) and continues the transferring process.

### Third Process Example

In the third processing example, in order to handle any direction of the transfer of the content, a straight line from the center of the circumscribed sphere of the space (room) in which the display unit 4 is arranged to the content is used to determine whether the content has attained the transfer start position of a corresponding one of the contents.

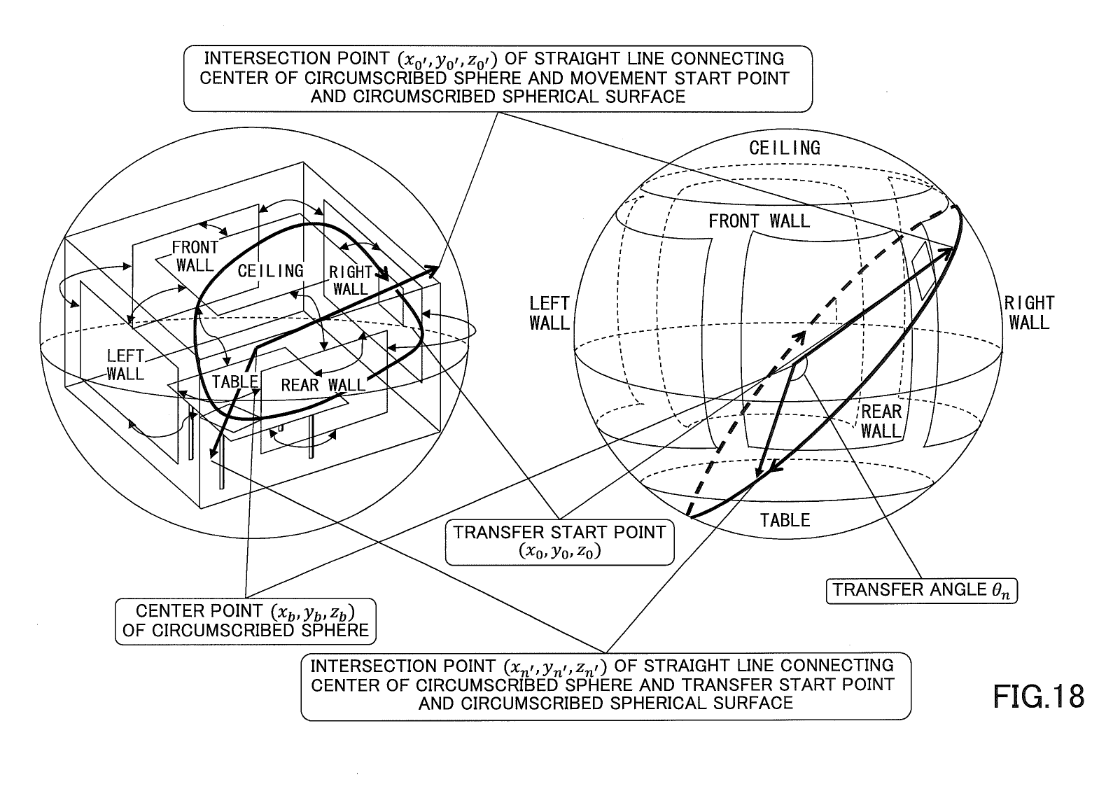

FIG. 18 is a diagram illustrating an operation example in the third process example, in which a left diagram indicates the arrangement of the displays in the room and the circumscribed sphere, and a right diagram indicates the outlines of the respective displays being projected on spherical surfaces of the circumscribed sphere. In this state, for example, when an operation for vigorously transferring the content displayed on the right wall to a diagonally lower right direction is performed, the content enters the right wall again via the rear wall, the table, and the front wall in a sequential order as indicated by a thick line. Thereafter, when the content attains the transfer start position, the angle formed between the straight line from the center of the circumscribed sphere to the transfer start position for each content and the straight line from the center of the circumscribed sphere to the position of the transferred content may be regarded to be of zero value and the transfer is stopped. Asa result, even when the transfer operation is too strong without adjustment, it is possible to prevent the content from continuing circling around.

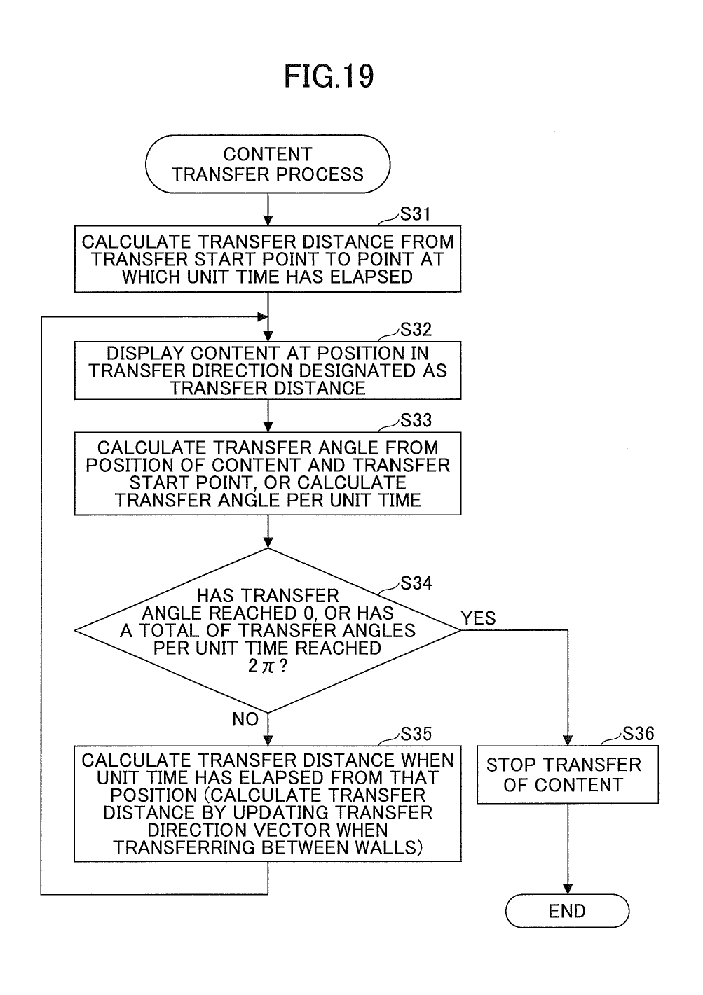

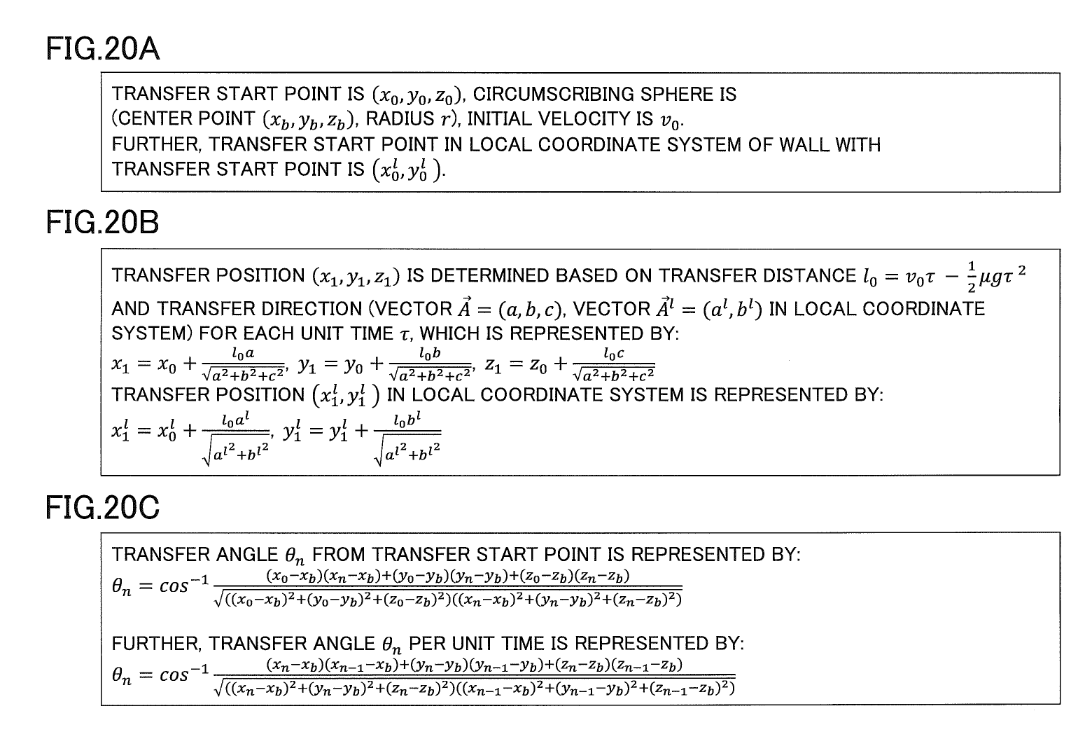

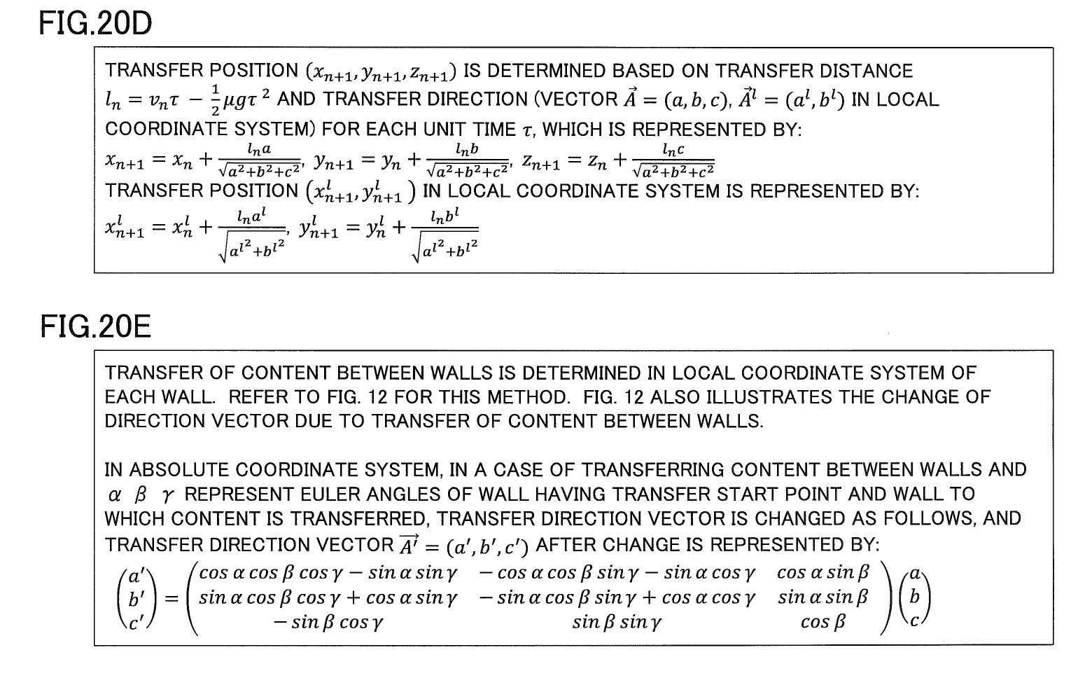

FIG. 19 is a diagram illustrating a flowchart in the third process example, which indicates a process corresponding to the content transfer process (step S108) in FIG. 9. In FIG. 19, when starting the processing, the content transfer processor 15 calculates a transfer distance between the transfer start point and a point at which a unit time has elapsed from the transfer start point (step S31). This calculation is performed as illustrated in FIG. 20B on the basis of assumption illustrated in FIG. 20A.

Referring back to FIG. 19, the content transfer processor 15 subsequently displays the content at a position in the transfer direction designated as the transfer distance (step S32).

The content transfer processor 15 subsequently calculates a transfer angle from the position of the content and the transfer start point, or calculates the transfer angle per unit time (step S33). This calculation is performed as illustrated in FIG. 20C.

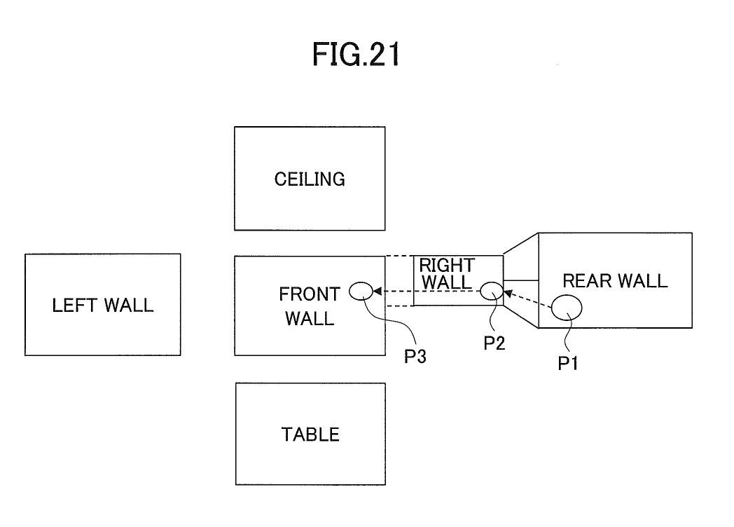

Note that the transfer angle per unit time is calculated in order to handle a case where the resolution and the connection range of the display are different between displays, as illustrated in FIG. 21. That is, in FIG. 21, the right side of the right wall is connected along the entire range of the left side of the rear wall such that magnification or compression may be performed, however, the left side of the right wall is connected only to the upper half of the right side of the front wall. Therefore, when the content C1 at the lower position P1 on the rear wall is assumed to horizontally be moved to the left, the content C1 will also be moved to a lower position P2 on the right wall; however, when the content C1 is further moved to the front wall, the content C1 will be moved to an upper position P3 on the front wall. Accordingly, the position will be misaligned only with respect to the transfer angle between the transfer start time and the current position of the content. Thus, in such a case, it is preferable to obtain the transfer angle per unit time, and accumulate the obtained transfer angles in order to determine, based on the accumulated transfer angles, the position to which the content is transferred.

Referring back to FIG. 19, the content transfer processor 15 determines whether the transfer angle has attained 0 (a value that may be regarded as 0 in consideration of an error) or whether a total of the transfer angles per unit time has attained 2π radians (a value that may be regarded as 2π radians in consideration of an error) corresponding to a circumference (a turn) (step S34).

Subsequently, when the content transfer processor 15 determines that the transfer angle has not attained 0 or the total of the transfer angles per unit time has not attained 2π radians (No in step S34), the content transfer processor 15 calculates the transfer distance at a time at which the unit time has elapsed from that position (calculates the transfer distance by updating the transfer direction vector when transferred between walls) (in step S35). This calculation is performed as illustrated in FIGS. 20D and 20E.

Referring back to FIG. 19, when the content transfer processor 15 determines that the transfer angle is 0 or the total of the transfer angles has attained 2π (Yes in step S34), the content transfer processor 15 stops transferring the content (step S36).

### Fourth Process Example

In a fourth process example, instead of stopping the transferred content abruptly at the boundary or at the transfer start position in the process example described above, the transferred content will be stopped naturally by setting of the dynamic friction coefficient such that the local maximum value of the dynamic friction coefficient will be at the boundary or at the transfer start position. In addition, since an increase in the dynamic friction coefficient near the boundary or the like will hinder the start of transfer, the dynamic friction coefficient is reduced immediately after the start of the transfer.

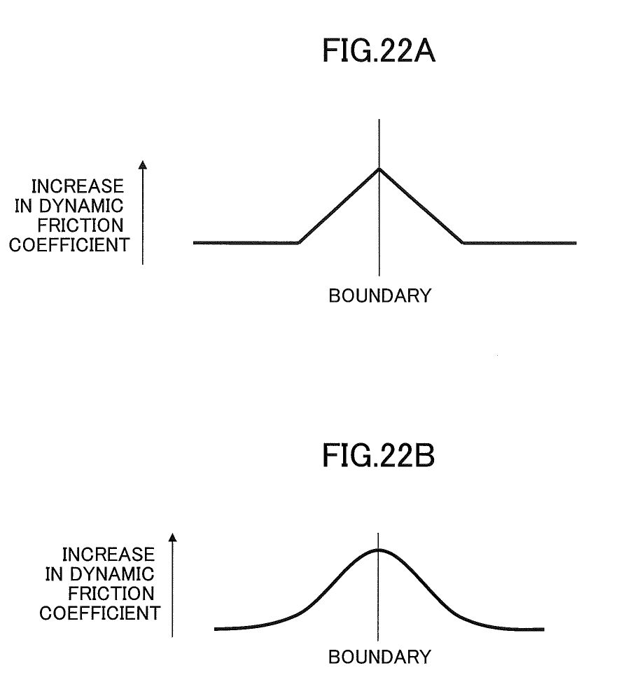

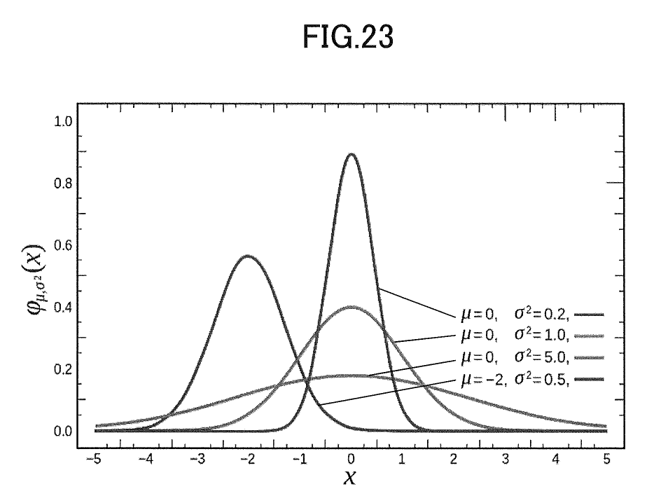

FIGS. 22A and 22B are diagrams illustrating an example of setting of a dynamic friction coefficient in the vicinity of a boundary in the fourth process example. In FIG. 22A, the dynamic friction coefficient is linearly increased in the vicinity of the boundary or the like. In this case, the dynamic friction coefficient may be set by a linear equation based on positional coordinates of the content. In FIG. 22B, the dynamic friction increases in a curve in the vicinity of the boundary or the like. In this case, the dynamic friction coefficient may be set by a formula such as a normal distribution with respect to positional coordinates of the content. FIG. 23 is a diagram illustrating examples of a normal distribution, indicating that various characteristics may be obtained by changing the mean or dispersion value.

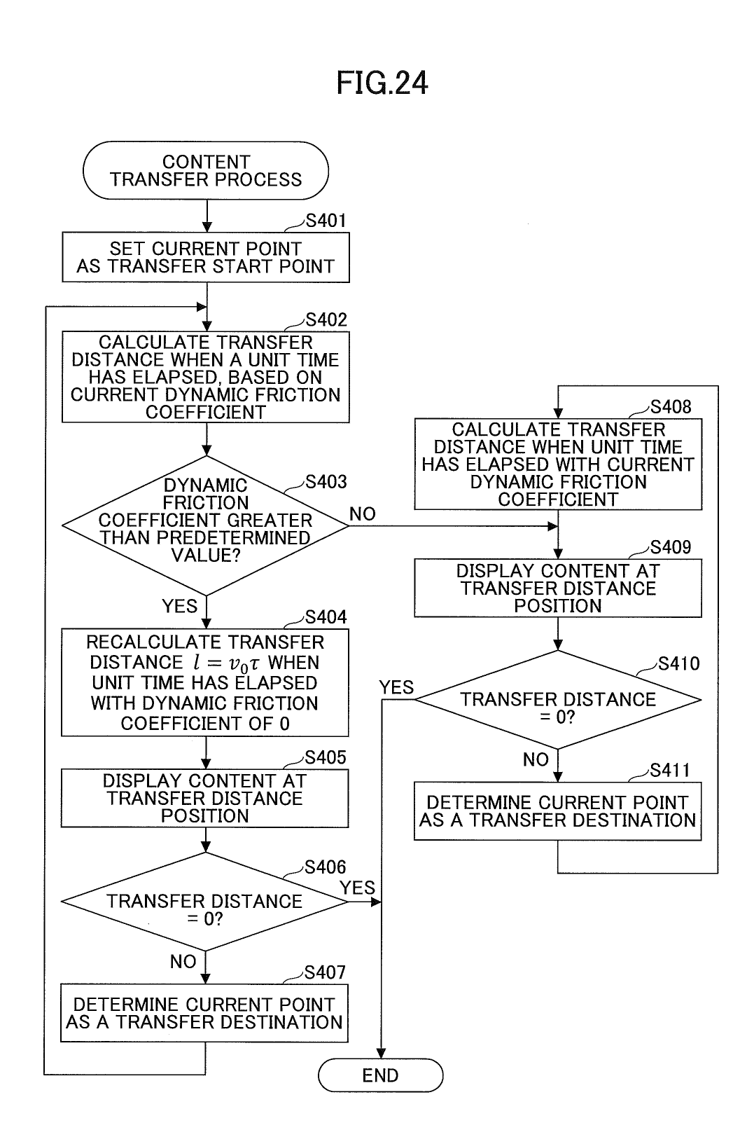

FIG. 24 is a diagram illustrating a flowchart in the fourth process example, which indicates a process corresponding to the content transfer process (step S108) in FIG. 9. In FIG. 24, when starting the process, the content transfer processor 15 sets a current point as a transfer start point (step S401).

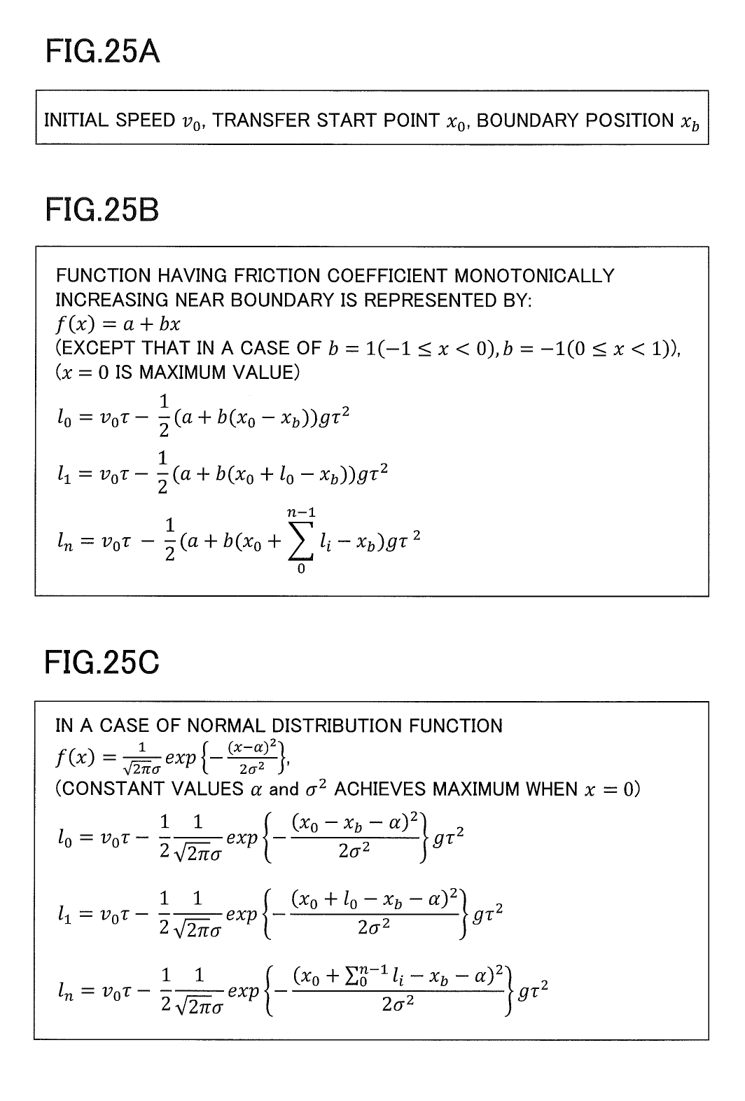

Subsequently, the content transfer processor 15 calculates the transfer distance at a time at which a unit time has elapsed, based on the current dynamic friction coefficient (step S402). On the basis of the assumption illustrated in FIG. 25A, the calculation is performed as illustrated in FIG. 25B with respect to the characteristic of FIG. 22A, and the calculation is performed as illustrated in FIG. 25C with respect to the characteristic of FIG. 22B. In FIGS. 25B and 25C, l₀ is the first transfer distance of the first unit time after the start of transfer, l₁ is the second transfer distance of the second unit time subsequent to the first unit time and lₙ is the (n−1)th transfer distance of the (n−1)th unit time.

Referring back to FIG. 24, the content transfer processor 15 determines whether the dynamic friction coefficient is greater than a predetermined value (step S403). When the content transfer processor 15 determines that the dynamic friction coefficient is greater than the predetermined value (Yes in step S403), the content transfer processor 15 recalculates the transfer distance l=v₀τ at a time for which the unit time has elapsed, for example, with a dynamic friction coefficient of 0 (step S404), and displays the content at the transfer distance position (step S405).

Subsequently, the content transfer processor 15 determines whether the transfer distance is 0 (step S406). When the content transfer processor 15 determines that the transfer distance is not 0 (No in step S406), the content transfer processor 15 determines the current point as a transfer destination (step S407) and returns to the calculation of the transfer distance (step S402). When the content transfer processor 15 determines that the transfer distance is 0 (Yes in step S406), the content transfer processor 15 ends the process.

Further, when the content transfer processor 15 determines that the dynamic friction coefficient is not greater than the predetermined value (No in step S403), the content transfer processor 15 displays the content at the transfer distance position (step S409), and determines whether the transfer distance is 0 (step S410).

When the content transfer processor 15 determines that the transfer distance is not 0 (No in step S410), the content transfer processor 15 calculates the transfer distance at a time at which the unit time has elapsed with the current dynamic friction coefficient (step S408), using the current time as the transfer destination (step S411), and shifts to the display of the content (step S409). When the content transfer processor 15 determines that the transfer distance is 0 (Yes in step S410), the content transfer processor 15 ends the process.

### Local Coordinates and Absolute Coordinates

Local coordinates are coordinates of a two-dimensional plane of the display area of each display unit 4. For example, a lower left corner of each display unit 4 is the origin, a vertical axis is an x axis, and a horizontal axis is a y axis. Absolute coordinates are physical three-dimensional coordinates.

Displaying (drawing) content and transferring determination of content between displays in each of the process examples described above may preferably be performed with local coordinates, and calculating the transfer angle in the third process example may preferably be performed with absolute coordinates. The transfer of contents is more easily to be determined with local coordinates. The transfer angle is more easily to be calculated with absolute coordinates.

### Transfer Determination Between Displays

The arrangement of the display of FIG. 10 will be described with an example. It is assumed that the origin of the local coordinates of the display on the right wall is the lower left corner, the size of the display area in the vertical direction (x axis direction) is aᵣ, and the size of the display area in the right direction (y axis direction) is bᵣ.

It is assumed that when the content is on the right wall, the original position before transfer is (xₙ, yₙ) and the position of the destination after transfer is (xₙ₊₁, yₙ₊₁), such that 0≤xₙ₊₁≤aᵣ, 0≤yₙ₊₁≤bᵣ is obtained. In this case, it is determined that the content is on the same right wall, and at other times the content may be determined to be transferred to the adjacent wall.

That is, the following may be determined: aᵣ<xₙ₊₁, 0≤yₙ₊₁≤bᵣ→transferred to the ceiling xₙ₊₁<0, 0≤yₙ₊₁≤bᵣ→transferred to the table 0≤xₙ₊₁≤aᵣ, bᵣ<yₙ₊₁→transferred to the rear wall 0≤xₙ₊₁≤aᵣ, yₙ₊₁<0→transferred to the front wall.

In transferring the content to each position, when the direction of the local coordinates is the same (e.g., the walls of the left and right and front and rear are in the same direction), the vector in the transfer direction will not change. When x and y axes are interchanged between the walls and the table, and the walls and the ceiling, x and y of the vector will be swapped. The direction of the axis that is opposite may be handled by reversing the signs. Calculation of the transfer angle is easily performed with absolute coordinates, in conjunction with calculation with the local coordinates.

### Interconversion Between Local Coordinates and Absolute Coordinates

In the display management table T1 (FIG. 7), the plane direction and the absolute coordinates of the base point and the screen physical size are managed for each display, which enables the local coordinates to be converted into absolute coordinates.

Such a management in the display management table T1 also enables conversion of the transfer direction vector on the display in one plane direction to the transfer direction vector on the display in the other plane direction.

The arrangement of the display of FIG. 10 will be described with an example. For example, for the right wall and the rear wall, when rotation is assumed at the Euler angles α, β, and γ, the transfer direction vector A=(xₐ, yₐ, zₐ) on the right wall becomes a transfer direction vector A′ as the content is transferred to the rear wall. A′=BA based on a rotation matrix B obtained from α, β and γ.

Rotation with respect to each display surface may be determined in advance by setting a reference surface (e.g., the front wall) and the rotation from the reference surface by the Euler angles or the like. In the example of FIG. 10, five rotations with respect to front wall, right wall, left wall, rear wall, ceiling and table are determined in advance. Accordingly, it is only necessary for the content to pass through the front wall once for the rotation between desired surfaces. For example, to rotate the content to the table from the right wall, it is sufficient to perform rotation from the right to the front and rotation from the front to the table. It is assumed that R represents the rotation matrix from the front wall to the right wall, L represents the rotation matrix from the front wall to the left wall, B represents the rotation matrix from the front wall to the rear wall, C represents the rotation matrix of the ceiling, and T represents the rotation matrix of the table. In this case, a transferred vector A′ of the transfer direction vector A from the right wall to the table is represented by the following formula:

A′=TR⁻¹A

where R⁻¹ is an inverse matrix of R. Likewise, it is possible to define transfers between all the adjacent walls (12 ways×2=24 ways, including the transferring of the content in the opposite directions).

### Overview

As described above, according to the above-described embodiments, it is possible to stop a content that has undergone a transfer operation without from continuing to be transferred even in a case where the display areas are arranged in a loop.

The display unit 4 is an example of a “display unit”. The display control apparatus 3 is an example of a “display controller”. The content transfer processor 15 is an example of a “content controller”. The loop determination unit 18 is an example of a “stop unit”.

According to an aspect of embodiments, it is possible to stop a content that has undergone a transfer operation from continuing to be transferred even in a case where the display areas are arranged in a loop.

The preferred embodiments are described above. The embodiments of the present invention are illustrated with specific examples; however, the present invention is not limited to these examples, and various alterations or changes may be made without departing from the gist and the scope of the claims of the present invention. Specifically, the present invention shall not be construed as being limited to details of the specific examples and accompanying drawings thereof.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

What is claimed is:

1. A content control apparatus comprising:
a plurality of display units having respective display areas arranged in a loop;
a memory storing a set of instructions of a content control program; and
one or more processors programmed to execute the set of instructions to perform a process including
displaying a content on any one of the plurality of display units,
transferring the content, in response to a sliding operation on the content displayed on a corresponding one of the display units, from the display unit acting as a starting point that initially displays the content, to pass sequentially through other display units, and
stopping the content in response to the transferred content being transferred to a predetermined position.

2. The content control apparatus as claimed in claim 1, wherein
the stopping includes stopping the content in response to the transferred content attaining a boundary set in any one of the display units.

3. The content control apparatus as claimed in claim 1, wherein
the stopping includes stopping the content in response to the transferred content attaining a boundary set as a transfer start position for each content.

4. The content control apparatus as claimed in claim 1, wherein
an angle is formed between a straight line extending from a center of a circumscribed sphere of a space in which the plurality of display units are arranged to a transfer start position for each content and a straight line extending from the center of the circumscribed sphere to a position of the transferred content, and wherein
the stopping includes stopping the content in response to the formed angle attaining a value determined as zero.

5. The content control apparatus as claimed in claim 1, wherein
an angle is formed between a straight line extending from a center of a circumscribed sphere of a space in which the plurality of display units are arranged to a transfer start position for each content and a straight line extending from the center of the circumscribed sphere to a position of the transferred content, and a transfer angle of the formed angle from a start of the transfer of the content is accumulated per unit time, and wherein
the stopping includes stopping the content in response to an accumulated value of the transfer angle from the start of the transfer attaining a value determined as a circumference of the circumscribed sphere.

6. The content control apparatus as claimed in claim 1, wherein
the transferring includes
decelerating the content, according to a dynamic friction coefficient indicating a local maximum value at the predetermined position, by applying a reduced value of the dynamic friction coefficient from a start of the transfer of the content throughout an interval of the dynamic friction coefficient exceeding a predetermined value, and
subsequently decelerating the content by applying the dynamic friction coefficient.

7. A non-transitory computer recordable storage medium storing a content control program for causing a computer to execute a process, the process comprising:
displaying a content on any one of a plurality of display units having respective display areas arranged in a loop;
transferring the content, in response to a sliding operation on the content displayed on a corresponding one of the display units, from the display unit acting as a starting point that initially displays the content, to pass sequentially through other display units; and
stopping the content in response to the transferred content being transferred to a predetermined position.

8. The non-transitory computer recordable storage medium as claimed in claim 7, wherein
the stopping includes stopping the content in response to the transferred content attaining a boundary set in any one of the display units.

9. The non-transitory computer recordable storage medium as claimed in claim 7, wherein
the stopping includes the content in response to the transferred content attaining a boundary set as a transfer start position for each content.

10. The non-transitory computer recordable storage medium as claimed in claim 7, wherein
an angle is formed between a straight line extending from a center of a circumscribed sphere of a space in which the plurality of display units are arranged to a transfer start position for each content and a straight line extending from the center of the circumscribed sphere to a position of the transferred content, and wherein
the stopping includes stopping the content in response to the formed angle attaining a value determined as zero.

11. The non-transitory computer recordable storage medium as claimed in claim 7, wherein
an angle is formed between a straight line extending from a center of a circumscribed sphere of a space in which the plurality of display units are arranged to a transfer start position for each content and a straight line extending from the center of the circumscribed sphere to a position of the transferred content, and a transfer angle of the formed angle from a start of the transfer of the content is accumulated per unit time, and wherein
the stopping includes stopping the content in response to an accumulated value of the transfer angle from the start of the transfer attaining a value determined as a circumference of the circumscribed sphere.

12. The non-transitory computer recordable storage medium as claimed in claim 7, wherein
the transferring includes
decelerating the content, according to a dynamic friction coefficient indicating a local maximum value at the predetermined position, by applying a reduced value of the dynamic friction coefficient from a start of the transfer of the content throughout an interval of the dynamic friction coefficient exceeding a predetermined value, and
subsequently decelerating the content by applying the dynamic friction coefficient.

13. A content control method executed by a computer, the content control method comprising:
displaying a content on any one of a plurality of display units having respective display areas arranged in a loop;
transferring the content, in response to a sliding operation on the content displayed on a corresponding one of the display units, from the display unit acting as a starting point that initially displays the content, to pass sequentially through other display units; and
stopping the content in response to the transferred content being transferred to a predetermined position.

14. The content control method as claimed in claim 13, wherein
the stopping includes stopping the content in response to the transferred content attaining a boundary set in any one of the display units.

15. The content control method as claimed in claim 13, wherein
the stopping includes the content in response to the transferred content attaining a boundary set as a transfer start position for each content.

16. The content control method as claimed in claim 13, wherein
an angle is formed between a straight line extending from a center of a circumscribed sphere of a space in which the plurality of display units are arranged to a transfer start position for each content and a straight line extending from the center of the circumscribed sphere to a position of the transferred content, and wherein
the stopping includes stopping the content in response to the formed angle attaining a value determined as zero.

17. The content control method as claimed in claim 13, wherein
an angle is formed between a straight line extending from a center of a circumscribed sphere of a space in which the plurality of display units are arranged to a transfer start position for each content and a straight line extending from the center of the circumscribed sphere to a position of the transferred content, and a transfer angle of the formed angle from a start of the transfer of the content is accumulated per unit time, and wherein
the stopping includes stopping the content in response to an accumulated value of the transfer angle from the start of the transfer attaining a value determined as a circumference of the circumscribed sphere.

18. The content control method as claimed in claim 13, wherein
the transferring includes
decelerating the content, according to a dynamic friction coefficient indicating a local maximum value at the predetermined position, by applying a reduced value of the dynamic friction coefficient from a start of the transfer of the content throughout an interval of the dynamic friction coefficient exceeding a predetermined value, and
subsequently decelerating the content by applying the dynamic friction coefficient.
